(19) United States
(12) Patent Application Publication
(10) Pub. No.: US 2007/0025904 A1
(43) Pub. Date: Feb. 1, 2007

(54) Preparation of a composition comprising an alkaline earth metal oxide and a substrate having a reduced amount of grit

(76) Inventors: David R. Skuse, Cornwall (GB); Nigel V. Jarvis, Cornwall (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/572,464

(22) PCT Filed: Sep. 28, 2004
(86) PCT No.: PCT/US04/31700

§ 371 Date: Sep. 5, 2006

Related U.S. Application Data
(60) Provisional application No. 60/507,109, filed on Oct. 1, 2003.

(51) Int. Cl. C01F 5/24; B01J 19/00

(52) U.S. Cl. 423/430; 423/165; 422/129

(57) ABSTRACT

The present invention relates to a composition comprising an alkaline earth metal carbonate and a substrate, where the composition has a reduced amount of grit, such as an amount less than or equal to about 0.5% by weight relative to the total weight of the composition. The composition can be a filler composition for use in, for example, paper making applications. Where the alkaline earth metal is a calcium carbonate, the grit can be reduced by degritting a slaked lime slurry prior to precipitation of the alkaline earth metal with the substrate. The degritting can be performed by hydrocycloning the lime slurry. The invention also relates to a method of coprecipitating calcium carbonate onto a substrate, and to a method of reducing grit in such compositions. The invention also relates to uses of these compositions, such as in paper-making applications, and to systems for producing these compositions.

This application claims priority to U.S. Provisional Patent Application No. 60/507,109, filed Oct. 1, 2003.

The present invention relates to a composition comprising an alkaline earth metal carbonate and substrate, where the composition has a reduced amount of grit. The composition can be prepared by coprecipitating the alkaline earth metal carbonate with the substrate. The composition can, for example, be a filler composition for use in applications such as paper making. The invention also relates to a method for reducing the grit in the composition, and to a paper comprising the composition having a reduced amount of grit. The source of the substrate can be an aqueous medium containing fibers, particles, or mixtures thereof.

The inventive compositions can be used as a particulate filler or pigment material in filler- or pigment-containing compositions, such as in paper-making applications. Thus, it is desirable that these compositions offer useful optical properties, such as at least one property chosen from whiteness, brightness, and opacity, among others, and improved strength-related properties, which can allow higher filler levels. Retention of filler can also be improved.

The coprecipitation of fines with the alkaline earth metal carbonate has been used to treat fines-containing streams from industrial processes, such as fines-containing streams generated during paper making (e.g. whitewater or effluent streams) or wet-mineral refining. Fines can be difficult to separate from the water by conventional procedures. It is known to recover fines by precipitating an alkaline earth metal carbonate onto the fines to form a fines/precipitate composite that can be subsequently separated from the fines-containing stream.

Additionally, it is known to precipitate alkaline earth metal carbonate onto fibers, such as cellulose fibers (i.e. long fibers or ‘virgin’ fibers) derived from refined pulp and used in papermaking processes to form composites, thereby increasing retention of the fibers in the papermaking process.

Composites prepared by coprecipitation with fibers and/or fines often contain a significant amount of grit that can result in diminished optical properties. Once the composite is formed, grit is difficult to separate from the solid composite. Grit removal reduces the visible contamination in the product, which is desirable when the composite is subsequently used as a pigment or filler material, and can result in a sheet with less defects.

It is known to degrit a fiber or fines-containing stream by various purification processes. However, these processes alone are sometimes not sufficient to produce a composition that is sufficiently grit free, for example for use as filler or pigment material.

Accordingly, there remains a need for a composition having a reduced amount of grit.

One aspect of the present invention provides a filler composition, comprising a substrate, and an alkaline earth metal carbonate precipitated on the substrate, wherein the filler composition contains grit in an amount less than or equal to about 0.5% by weight relative to the total weight of the composition.

Another aspect of the present invention provides a method of precipitating calcium carbonate, comprising:
(a) providing a slaked lime slurry;
(b) degritting the slaked lime slurry;
(c) combining the degritted slaked lime with a substrate; and
(d) precipitating the degritted slaked lime in (c) as calcium carbonate in the presence of the substrate.

Another aspect of the present invention provides a method of reducing grit in a composition, comprising:
(a) providing a slaked lime slurry;
(b) degritting the slaked lime slurry;
(c) combining the degritted slaked lime with a substrate; and
(d) precipitating the degritted slaked lime in (c) as calcium carbonate in the presence of the substrate.

The present invention generally provides a composition comprising a substrate and an alkaline earth metal carbonate, where the composition has a reduced amount of grit. The inventors have discovered that by removing grit from the reagents leading to the alkaline earth metal carbonate, the composition can have a reduced amount of grit compared to compositions prepared by prior art processes.

Accordingly, one aspect of the present invention provides a filler composition comprising an alkaline earth metal carbonate and a substrate, wherein the filler composition has a reduced amount of grit. In one aspect, grit refers to undesired particulate impurities, such as unreacted overburned lime, over-sized slaked lime, sand and/or other materials. In one aspect the grit has a diameter of at least about 35 μm, such as diameters of at least about 45 μm, or at least about 50 μm.

In one aspect, a composition having a reduced amount of grit refers to a composition having less than or equal to about 0.5% grit by weight relative to the total weight of the composition, such as an amount of less than or equal to about 0.3%, about 0.2%, about 0.1%, about 0.05%, or about 0.01% grit by weight relative to the total weight of the composition. In one aspect, the composition is substantially grit free.

In one aspect, the alkaline earth metal carbonate is a precipitated alkaline earth metal carbonate. The alkaline earth metal can be calcium. In another aspect, the alkaline earth metal can be magnesium. In another aspect, the alkaline earth metal carbonate is precipitated on the substrate.

For example, the alkaline earth metal carbonate can be a calcium carbonate, such as a precipitated calcium carbonate (PCC). The calcium carbonate can be precipitated by carbonating a suspension containing calcium hydroxide. Where the alkaline earth metal is magnesium, the corresponding hydroxide of the alkaline earth metal is magnesium hydroxide.

In one aspect, the substrate is chosen from particulate materials and fibrous materials, i.e., the substrate comprises particulate and/or fibrous materials. In another aspect, the substrate may comprise a mixture of both fibrous and particulate materials.

For example, the substrate source can be a suspension comprising organic and/or inorganic particles and/or fibers from any of a variety of sources. In one aspect, the substrate includes a mixture of particles and fibers from a fines-containing waste stream, such as a ‘whitewater’ stream or a paper plant effluent stream. In one aspect, the inorganic material comprises at least about 2%, or at least about 5% by weight of the total solid waste material. In another aspect, the inorganic component is present in an amount ranging from about 2% to about 85% by weight of the total solids of the waste material. For example, the substrate may include cellulosic fibers, ink particles, latex particles and resin particles, e.g. urea-formaldehyde, and mixtures thereof, any of which may be bound to inorganic particles.

In the papermaking process, a pre-prepared paper stock, typically comprising an aqueous suspension of fibers and mineral pigments/fillers, is formed into a sheet on the wire of the papermaking machine. Water and a portion of the smaller entrained fibers and mineral pigments/filler particles pass through the wire of the papermaking machine as a fiber-containing stream that is commonly referred to as ‘whitewater’.

Whitewater can be discarded as waste. However, in order to increase efficiency of material usage, at least a portion of the whitewater is typically recirculated and reused into the papermaking stock by what is called the “primary circulation loop”. Nonetheless, more whitewater is produced than can be recirculated. The excess, or “waste,” whitewater is typically withdrawn from the primary circulation loop and is processed in a secondary circulation loop which separates as much of the solid material as possible for reuse in the preparation of paper stock. Excess water from the secondary circulation loop is either reused in the paper making plant, or may be discharged as an effluent stream.

In one aspect, the substrate source is a new fiber-containing stream. The fibers can originate from any source, as known to one of ordinary skill in the art. For example, the substrate can comprise new or “unused” fibers such as long fibers (i.e. “virgin fibers”) produced by refining pulp. In one aspect, the fibers have a size such that the resulting composition according to the present invention is sufficient for use in paper making applications.

In another aspect, the substrate may comprise a fiber-containing stream derived from a recycled material such as processed re-pulped waste paper or “broke”. During the paper making process, a significant amount of the formed sheet has defects, imperfections or is otherwise unsuitable for use. This material, referred to as ‘broke’, is often re-pulped and reused in the preparation of papermaking stock to increase the efficiency of the paper making plant. In another embodiment, the fiber-containing stream may be derived from repulped paper recycled by consumers. When the substrate includes a fiber-containing stream derived from broke or recycled paper, the substrate can also include other materials such as mineral pigment particles (e.g., a white mineral such as kaolin, calcium carbonate, talc, TiO₂, etc.), ink particles, latex particles, and resin particles, e.g. urea-formaldehyde, and mixtures thereof.

In another aspect, the substrate may comprise a particulate mineral, such as for example a white particulate mineral of the sort commonly used as a white pigment or filler in papermaking. For example, and not limitation, the substrate can include particles of kaolin, natural (ground) calcium carbonate, precipitated calcium carbonate, talc, TiO₂, etc. In one aspect, the substrate includes preformed crystals of precipitated calcium carbonate. In another aspect, the substrate includes kaolin stacks and/or plates.

In one aspect, the substrate source can be a stream containing small particles and/or fibers, collectively referred to herein as “fines.” In one aspect, the fines comprise particulate materials having an average diameter less than or equal to about 300 μm, such as an average diameter less than or equal to about 250 μm, less than or equal to about 150 μm, or an average diameter less than or equal to about 75 μm. In one aspect, the fines comprise particles having an average diameter less than about 50 μm, such as an average diameter of less than about 5 μm. In another aspect, the particles have an average particle diameter of less than about 2 μm, an average particle diameter of than about 1 μm. In one aspect, the fines comprise fibers. In one aspect, the fines comprising fibers can pass through a screen having a 76 μm aperture mesh.

In one aspect, the fines can be defined from TAPPI Standard No. T261 cm-90 “Fines fraction of paper stock by wet screening” (1990), which describes a method for measuring the fines content of paper making stock and specifies that fines are those particles which will pass through a screen having a 76 μm aperture mesh. In this definition “particles” includes material selected from organic particles, inorganic particles, and microfibers.

In one aspect, the substrate comprises fines that can pass through a round hole having a diameter of about 300 μm (50 mesh), such as a diameter of about 250 μm (60 mesh), a diameter of about 150 μm (100 mesh), or a diameter of about 74 μm (200 mesh). In one aspect, the substrate can pass through a 50 mesh screen, a 60 mesh screen, a 100 mesh screen, or a 200 mesh screen.

In one aspect, the method for precipitating the calcium carbonate comprises providing a slaked lime slurry, and carbonating the slurry. The present inventors have observed that the production of a slaked lime slurry can generate a significant amount of undesired residue, such as grit. Grit having a size similar to or smaller than the substrate and/or the precipitated alkaline earth carbonate can be difficult to remove from the composition with typical screening methods. When the grit is present in a slurry, separating the grit poses a difficult problem because the viscosity of the slurry can cause the slurry to exist in a gel-like state. Screening may not be effective where the grit particles are comparable in size with the composition. If the PCC is formed around a grit particle, separation may not be possible. Screening the slaked lime slurry may remove particles larger than about 150 μm. For particles finer than 100 mesh, however, screening can lead to lower production throughput due to screen blinding.

Accordingly, another aspect of the present invention provides a method of coprecipitating calcium carbonate onto a substrate. The method comprises:
(a) providing a slaked lime slurry;
(b) degritting the slaked lime slurry;
(c) combining the degritted slaked lime with a substrate; and
(d) precipitating the degritted slaked lime in (c) as calcium carbonate in the presence of the substrate.

The slaked lime in (a) can be a suspension of calcium hydroxide in an aqueous medium. Calcium carbonate can be formed by carbonation of the lime slurry, such as by the addition of CO₂.

The slaked lime slurry can be prepared, for example, by slaking an alkaline earth metal oxide, such as calcium oxide, or by adding calcium hydroxide to an aqueous medium.

In one aspect, the alkaline earth metal hydroxide, such as calcium hydroxide, is present in the suspension during the slaking process in an amount ranging from about 0.5 mol to about 3.0 mol per liter, such as an amount ranging from about 0.5 mol to about 2.0 mol per liter.

The temperature of the aqueous medium containing the alkaline earth metal hydroxide, such as a slaked lime slurry, may range from about 0° C. to about 100° C. The temperature can rise during the slaking process. If the aqueous medium is not at the appropriate temperature after slaking, it may be heated or cooled to achieve the desired temperature before further use.

In one aspect, the degritting in (b) is performed with any degritting procedure suitable for removing grit, such as at least one of screening, fine screening, classifying, and centrifuging. The degritting in (b) can be performed with a cyclone, for example a hydrocyclone. In another aspect, the degritting in (b) can be performed using a centrifuge, such as a solid bowl decanter centrifuge, a disc nozzle centrifuge, or the like.

In one aspect, a cyclone is a device for the separation of particles from gas or fluids. The mixture containing the components to be separated is subjected to centrifugal forces that differentiate the different components based on densities and or/particle size and/or shape factor, among other factors. A cyclone differs from a centrifuge in that it does not have spinning parts. Instead, it comprises a top portion comprising a cylindrical chamber connected to a conical chamber where the narrower end of the cone points downwards towards a spigot. When a vortex is created in the cyclone, the centrifugal force causes the denser or larger material to move towards the outer rim of the chamber. The denser or larger material progresses downwards along the cyclone wall where it discharges through the spigot. A reverse vortex forms at the spigot, creating a low pressure center along the cyclone axis. The less dense or smaller material flows upwardly and exits at a vortex finder, positioned at the top of the chamber at its axis.

In one aspect, a hydrocyclone is a specific type of cyclone useful for separating particulate material from water. When separating out grit from a slaked lime slurry, the grit is contained in the denser fraction while the lighter fraction contains the purified lime slurry.

The viscosity of the slaked lime slurry can be adjusted to enhance grit removal, for example, prior to introducing the slurry into a hydrocyclone. Optionally, the concentration of the slaked lime can be controlled to achieve the desired slurry dilution. In one aspect, the slaked lime slurry has a solids content ranging from about 2% to about 25%, such as a solids content ranging from about 5% to about 20%, or a solids content ranging from about 10% to about 20%, by weight relative to the total weight of the slurry.

The hydrocycloning can be carried out at pressures ranging from about 30 psi to about 60 psi. Such pressures can help reduce the apparent viscosity of the slurry and aid the separation of grit from the lime.

The design and dimensions of the hydrocyclone can also affect separation, such as the diameter of the vortex finder, the diameter of the chamber, and diameter of the spigot, among other dimensions. In one aspect, the vortex finder has a diameter ranging from 8 mm to about 20 mm, such as a diameter ranging from about 10 mm to about 20 mm and the spigot has a diameter ranging from about 3 mm to about 9 mm. In one aspect, the diameter of the vortex finder is about 0.2 to about 0.4 times the diameter of the cylindrical chamber of the cyclone, such as a vortex finder diameter of about 0.3 to 0.35 times the diameter of the cylindrical chamber.

In one aspect, the slurry is screened prior to hydrocycloning. One of ordinary skill in the art can readily select a screen having an appropriate mesh size, such as a screen of about 60 mesh or about 100 mesh. In one aspect, the amount of grit removed by screening is at least about 10,000 ppm, such as an amount of at least about 25,000 ppm or at least about 50,000 ppm.

The temperature of the slurry in the hydrocyclone can range from, for example, about 25° C. to about 90° C.

In one aspect, the combining in (c) comprises combining the degrifted slaked lime in (b) with the substrate. The source of the substrate can be a new fiber-containing stream, a fines-containing stream, or a waste stream, such as a waste stream containing fines and/or fibers.

In one aspect, the precipitating in (d) comprises precipitating the alkaline earth metal carbonate, or degritted slaked lime in (c), in the presence of the substrate. For example, the precipitation can be performed by adding carbon dioxide to the degritted slaked lime combined with the substrate in (c). In another example, a suspension containing a separately prepared suspension of an alkaline earth metal hydroxide can be combined with a substrate containing the finds and/or fibers, followed by carbon dioxide addition.

In one aspect, the alkaline earth metal carbonate is precipitated in (d) by a carbonation reaction, such as by addition of a carbon dioxide-containing gas. The carbon dioxide-containing gas may be substantially pure carbon dioxide, such as the gas supplied in a compressed gas cylinder, or may be present in a mixture with other gases. The supplied carbon dioxide gas may be diluted with other gases, such as air, nitrogen, etc. The carbon dioxide may be present as a mixture of spent gases such as flue gases, e.g., obtained from a paper mill process (e.g. from boilers, etc.). The gas may be applied under pressure.

The addition of a carbon dioxide-containing gas to an aqueous medium containing slaked lime may be continued until the pH of the aqueous medium has fallen to a pH of less than about 9.0, such as a pH less than about 7.0. The pH can be monitored until it falls and then becomes stable. This pH behavior can indicate that all of the alkaline earth metal ions have been consumed, such as by consumption of the calcium hydroxide present in the aqueous medium.

It is known, for example, that the reaction conditions employed to produce a precipitated calcium carbonate product can be selected to aim for a predominant precipitate crystal form, e.g., scalenohedral, aragonite or rhombohedral, which will give increased brightness from the crystals when used in paper. Such reaction conditions may be selected as understood by one of ordinary skill in the art.

The reactor vessel in which the precipitation reaction is carried out to produce the composition may take various forms depending on the process conditions required to be operated as described herein. Reactor vessels useful for the production of precipitated calcium carbonate from slaked lime and carbon dioxide gas may be employed. The reaction may be carried out as a batch, continuous or semi-continuous process as appropriate in a wide variety of reactors.

As discussed herein, the substrate source can be a waste stream or other papermaking process stream. The waste stream or papermaking process stream may be pre-treated to render the suspension suitable for precipitation prior to the combining in (c), or after the combining in (c) and prior to the precipitation of the alkaline earth metal carbonate in ,(d). For example, the waste stream suspension may be concentrated or diluted as described hereinafter or the suspension may be subjected to a processing step, for example, treatment by a surface treatment agent in a known way to give the particles and/or fibers in the suspension a surface chemical and/or physical functionality.

Efficient dispersion and dissolution of the alkaline earth metal hydroxide may also be assisted by agitation, e.g., by stirring of the aqueous suspension, to promote uniform distribution of the particulate solid material comprising the hydroxide. This agitation can be performed in any of steps (a) to (d).

Another aspect of the present invention provides a method of reducing grit in a composition. The method comprises:
(a) providing a slaked lime slurry;
(b) degritting the slaked lime slurry;
(c) combining the degritted slaked lime with a substrate; and
(d) precipitating the degritted slaked lime in (c) as calcium carbonate in the presence of the substrate.

In one aspect, the substrate is chosen from particulate and fibrous materials.

In one aspect, the amount of grit is reduced to the extent that the slaked lime slurry in (a) has an amount of grit of at least about 10,000 ppm, such as an amount of at least about (after screening) 25,000 ppm, and the degritted lime slurry after (b) has an amount of grit having at least one of the amounts described herein, such as an amount less than or equal to about 1000 ppm. In one aspect, the amount of grit is as high as about 50,000 ppm (up to 10%). In another aspect, the slaked lime slurry in (a) has an amount of grit of at least about 10,000 ppm and the degritted lime slurry after (b) has an amount of grit less than or equal to about 500 ppm, such as an amount of grit less than or equal to about 100 ppm.

In one aspect the composition may be used in any application, such as a filler or pigment for paper making, e.g., a paper comprising the filler composition according to the invention, or alternatively as a filler for other known particulate filler or extender and/or reinforcing applications, such as in polymer, paint, resin, cement, and concrete compositions, and the like. For example, the composition can be used as a filler in a polymer. The solids-containing suspension may, if required, be diluted for use at the user plant.

The aqueous suspension containing an aggregate of precipitate and fines formed by the method according to the present invention may be dewatered prior to supply for use in a user application, e.g., re-use in the paper mill. For example, processes such as filtration, sedimentation, centrifugation and/or evaporation may be used. Alternatively, the aqueous suspension or slurry may be delivered to a storage tank or directly to the user plant without substantial dewatering.

The product may be supplied in one of various concentrations in water. The concentration may range from dilute suspension form to dry particulate solids. The product after formation in the method according to the present invention may or may not be treated as appropriate, e.g., by dewatering or not, so that it may be delivered to the user plant, e.g., paper making mill, in the required concentration.

If desired, a reducing or oxidizing bleaching agent may be added to the suspension containing the composition to improve its whiteness. The reducing bleaching agent may be, for example, a dithionite salt such as sodium or zinc dithionite, or zinc dust, sulphur dioxide, and formamidine sulfinic acid (FAS). The amount of the reducing bleaching agent used can range from, for example, about 1.5 to about 7.5 grams of the reducing bleaching agent per kilogram of dry particulate material.

The suspension containing the precipitated alkaline earth metal carbonate and entrained substrate (e.g., an industrial by-product) may be added directly in its relatively dilute form to a paper making composition to provide a filler for the paper making fibers. Alternatively, the suspension may be dewatered by any conventional method, for example by pressure filtration or in a centrifuge.

In any event, as will be clearly evident to those familiar with the paper making art, the product may be blended in various proportions with conventional filler materials, e.g., precipitated or natural (e.g. ground), calcium carbonate, kaolin and other clay minerals, metakaolin, talc, calcium sulphate etc., the ingredients and composition as well as the host fibers being selected according to the quality of paper required to be produced. In general, these materials are often in slurry form when they are mixed.

Another aspect of the present invention provides a system for precipitating calcium carbonate onto a substrate to produce a composition having less than or equal to about 0.5% grit, said system comprising:
a slaked lime entry point for introducing slaked lime;
a degritter for removing grit from the slaked lime;
a substrate entry point for introducing a substrate; and
a reactor for receiving degritted slaked lime from the degritter and substrate from the substrate entry point, and for carbonating the degritted slaked lime, thereby precipitating calcium carbonate onto the substrate to form the composition.

In one aspect, the substrate can comprise a suspension of fibers, particles, or mixtures thereof. For example, the substrate can comprise new fibers and/or used fibers. In another example the substrate comprises the solid constituents of a process stream or waste stream such as white water, or effluent. In yet another example, the substrate comprises particles of a mineral such as kaolin, calcium carbonate, talc, or TiO₂.

In one aspect, the degritter can be any device for degritting as described herein, e.g., screens or cyclones. In another aspect, the degritter can be a combination of devices, such as a combination of a screen and cyclone. For example, the source of alkaline earth metal can be passed through a screen of the system and subsequently introduced into a hydrocyclone. In another aspect, the degritter can be a centrifuge, such as a solid bowl decanter centrifuge, a disc nozzle centrifuge, or the like.

In one aspect, the system can be designed to carry out any of the processes as a batch process, or as a continuous or semi-continuous process as appropriate in a wide variety of reactors. The processes include degritting the slaked lime, combining the degritted slaked lime with the substrate, carbonating the slaked lime, and precipitating the degritted slaked lime as calcium carbonate.

The invention will be further clarified by the following non-limiting examples, which are intended to be purely exemplary of the invention.

### EXAMPLE

This Example describes the slaking and hydrocycloning of a lime that is known to have high levels of grit residue. Slaked lime was prepared by adding 1300 g of lime to 10 L of water at 50° C. with good agitation over a period of 5 minutes. The slaked lime was allowed to mix for a further 30 min before screening at 60 mesh. The maximum temperature achieved was typically, approximately 750° C. Several slaking experiments were carried out to give sufficient material for cycloning. At the end of the slaking process, the sample was screened at 60 mesh (250 μm).

### Slaking

The following results were recorded during slaking:

| | | |
|---|---|---|
| greater than 60 mesh (250 μm) residue - | 5.9 | wt. % |
| Brookfield viscosity (at 60° C. and 100 rpm) - | 70 | mPa · s |
| Solids content - | 14.4 | wt. %. |

### Hydrocycloning

The results from the cyclone experiments (conducted with a hydrocyclone) are given in the Table below. The hydrocycloning was carried out on screened (60 mesh) slaked lime at about 400° C. using Axsia Mozley 2″ cyclones at 50 psi. Different cyclone set-ups were used (e.g., 11 and 14 mm vortex finders with 6.4 and 8.0 mm spigots) to assess the degritting potential. Samples of feed, cyclone product and cyclone underflow were taken to enable measurements of recovery and level of residue.

Table: Axsia Mozley 2″ cyclone, 50 psi, feed temperature 40° C.

| Vortex | | | | | | >45 μm |
|---|---|---|---|---|---|---|
| Finder | Spigot | | Solids | Wt Slurry | Recovery | Residue |
| (mm) | (mm) | Sample | (wt. %) | (g) | (wt. %) | (wt. %) |
| | | Feed | 14.6 | | | 2.5 |
| 11 | 6.4 | Product | 14.0 | 4965 | 76.8 | 0.0108 |
| 11 | 6.4 | Underflow | 17.2 | 1218 | | 10.0 |
| 11 | 8 | Product | 13.6 | 3029 | 67.6 | 0.0124 |
| 11 | 8 | Underflow | 16.0 | 1235 | | 6.4 |
| 14 | 6.4 | Product | 13.7 | 3967 | 87.0 | 0.0095 |
| 14 | 6.4 | Underflow | 17.9 | 453 | | 11.6 |
| 14 | 8 | Product | 13.8 | 4380 | 79.8 | 0.0095 |
| 14 | 8 | Underflow | 16.3 | 940 | | 6.7 |

All cyclone products contained low levels of residue, around 100 ppm.

As expected, the larger vortex finder and smaller spigot gave the recovery at 87%.

This Example has shown the potential of using hydrocyclones to produce grit free slaked lime. 45 μm residue levels have been reduced from 25000 ppm in the feed to about 100 ppm after cycloning.

As an example, by computation a 50/50 alkaline earth metal carbonate/substrate composite produced using lime that has been screened but not gritted according to the process of the invention will contain approximately 9,000 to 10,000 ppm grit. By contrast, a composite containing 50/50 alkaline earth metal/substrate prepared according to the process of the invention, e.g., prepared from hydrocycloned lime, can contain approximately 35 ppm grit.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A filler composition, comprising:
at least one substrate; and
at least one alkaline earth metal carbonate precipitated on the substrate;
wherein the filler composition contains grit in an amount less than or equal to about 0.5% by weight relative to the total weight of the filler composition.

2. The composition according to claim 1, wherein the composition contains grit in an amount less than or equal to about 0.2% by weight relative to the total weight of the composition.

3. The composition according to claim 2, wherein the composition contains grit in an amount less than or equal to about 0.1% by weight relative to the total weight of the composition.

4. The composition according to claim 3, wherein the composition contains grit in an amount less than or equal to about 0.05% by weight relative to the total weight of the composition.

5. The composition according to claim 4, wherein the composition contains grit in an amount less than or equal to about 0.01% by weight relative to the total weight of the composition.

6. The composition according to claim 1, wherein the grit has a diameter of at least about 35 μm and is present in the composition in an amount of less than or equal to about 0.5% by weight relative to the total weight of the composition.

7. The composition according to claim 6, wherein the grit has a diameter of at least about 45 μm.

8. The composition according to claim 7, wherein the grit has a diameter of at least about 50 μm.

9. The composition according to claim 1, wherein the at least one substrate is chosen from particulate materials and fibrous materials.

10. The composition according to claim 1, wherein a source of the at least one substrate is a fiber-containing stream.

11. The composition according to claim 1, wherein a source of the at least one substrate is a fines-containing stream.

12. The composition according to claim 1, wherein a source of the at least one substrate is whitewater.

13. The composition according to claim 1, wherein a source of the at least one substrate is a fiber-containing stream comprising fibers derived from broke.

14. The composition according:to claim 1, wherein a source of the at least one substrate is a fiber-containing stream comprising fibers derived from paper.

15. The composition according to claim 1, wherein a source of the at least one substrate is an effluent stream.

16. The composition according to claim 15, wherein the effluent stream is from a paper making plant.

17. The composition according to claim 1, wherein the at least one substrate comprises a white mineral.

18. The composition according to claim 1, wherein the at least one substrate comprises calcium carbonate.

19. The composition according to claim 1, wherein the at least one substrate comprises precipitated calcium carbonate.

20. The composition according to claim 1, wherein the at least one substrate comprises kaolin.

21. The composition according to claim 1, wherein the at least one substrate comprises TiO₂.

22. The composition according to claim 1, wherein the at least one substrate comprises talc.

23. The composition according to claim 1, wherein the at least one alkaline earth metal carbonate is a precipitated alkaline earth metal carbonate.

24. The composition according to claim 1, wherein the at least one alkaline earth metal carbonate is calcium carbonate.

25. The composition according to claim 1, wherein the at least one alkaline earth metal carbonate is magnesium carbonate.

26. The composition according to claim 1, wherein the at least one substrate comprises at least one particulate material having a mean diameter less than or equal to about 300 μm.

27. The composition according to claim 26, wherein the at least one substrate comprises at least one particulate material having a mean diameter less than or equal to about 250 μm.

28. The composition according to claim 27, wherein the at least one substrate comprises at least one particulate material having a mean diameter less than or equal to about 150 μm.

29. The composition according to claim 27, wherein the at least one substrate comprises at least one particulate material having a mean diameter less than or equal to about 75 μm.

30. The composition according to claim 1, wherein the at least one substrate comprises at least one fibrous material having a mean length of less than or equal to about 75 μm.

31. The composition according to claim 1, wherein the at least one substrate passes through a round hole having a diameter of about 76 μm.

32. The composition according to claim 1, wherein the at least one substrate passes through a 50 mesh screen.

33. The composition according to claim 32, wherein the at least one substrate passes through a 100 mesh screen.

34. A paper comprising the composition according to claim 1.

35. The paper according to claim 34, wherein the paper further comprises at least one ingredient chosen from ground calcium carbonate, kaolin, metakaolin, talc, and calcium sulphate.

36. A polymer comprising the composition according to claim 1.

37. A method of precipitating calcium carbonate comprising:
(a) providing a slaked lime slurry;
(b) degritting the slaked lime slurry;
(c) combining the degritted slaked lime with at least one substrate; and
(d) precipitating the degritted slaked lime in (c) as calcium carbonate in the presence of the at least one substrate.

38. The method according to claim 37, wherein the degritted slaked lime in (c) is precipitated as calcium carbonate onto the at least one substrate.

39. The method according to claim 37, wherein the at least one substrate is chosen from particulate materials and fibrous materials.

40. The method according to claim 37, wherein the slurry in (a) comprises calcium hydroxide in an amount ranging from about 0.5 mol to about 3.0 mol per liter.

41. The method according to claim 37, wherein the slaked lime is screened prior to degritting.

42. The method according to claim 37, wherein the degritting in (b) comprises hydrocycloning the slurry with a hydrocyclone.

43. The method according to claim 42, wherein prior to introducing the slaked lime slurry in (a) into the hydrocyclone, the solids content of the slurry ranges from about 2% to about 25% by weight relative to the total weight of the slurry.

44. The method according to claim 42, wherein the slurry is introduced into the hydrocyclone at a pressure ranging from about 30 psi to about 60 psi.

45. The method according to claim 42, wherein the slurry in the hydrocyclone has a temperature ranging from about 25° C. to about 90° C.

46. The method according to claim 42, wherein the hydrocyclone has a vortex finder and a spigot, and a diameter of the vortex finder ranges from about 0.2 to about 0.4 times a diameter of the spigot.

47. The method according to claim 42, wherein the hydrocyclone has a vortex finder and a spigot, the vortex finder having a diameter ranging from about 8 mm to about 20 mm and the spigot having a diameter ranging from about 3 mm to about 9 mm.

48. The method according to claim 42, wherein the slaked lime is screened prior to hydrocycloning.

49. The method according to claim 41, wherein the slaked lime is screened with a 60 mesh screen.

50. The method according to claim 37, wherein a source of the at least one substrate in (c) is a fiber-containing stream.

51. The method according to claim , wherein a source of the at least one substrate in (c) is a fines-containing stream.

52. The method according to claim 37, wherein a source of the at least one substrate in (c) is whitewater.

53. The method according to claim 37, wherein a source of the at least one substrate in (c) is a waste stream.

54. The method according to claim 37, wherein prior to (d), the at least one substrate is pre-treated to render it suitable for precipitation.

55. The method according to claim 37, wherein the at least one substrate comprises a white mineral.

56. The method according to claim 37, wherein the at least one substrate comprises calcium carbonate.

57. The method according to claim 37, wherein the at least one substrate comprises kaolin.

58. The method according to claim 37, wherein the at least one substrate comprises TiO₂.

59. The method according to claim 37, wherein the at least one substrate comprises talc.

60. The method according to claim 37, wherein the precipitating in (d) is effected with carbon dioxide.

61. The method according to claim 60, wherein the precipitation with carbon dioxide addition is terminated when the pH of the slurry is less than about 9.0.

62. The method according to claim 61, wherein the precipitation with carbon dioxide addition is terminated when the pH of the slurry is less than about 7.0.

63. The method according to claim 37, wherein the composition formed after the precipitating in (d) is subjected to at least one bleaching agent.

64. The method according to claim 37, wherein the slurry comprising the composition formed after the precipitating in (d) is dewatered.

65. The method according to claim 37, wherein the slurry comprising the composition formed after the precipitating in (d) is diluted.

66. A paper comprising a composition made according to the process of claim 37.

67. The paper according to claim 66, wherein the paper further comprises at least one ingredient chosen from ground calcium carbonate, kaolin, metakaolin, talc, and calcium sulphate.

68. The paper according to claim 66, wherein the composition contains grit in an amount less than or equal to about 0.5% by weight relative to the total weight of the composition.

69. The paper according to claim 68, wherein the composition contains grit in an amount less than or equal to about 0.3% by weight relative to the total weight of the composition.

70. The paper according to claim 69, wherein the composition contains grit in an amount less than or equal to about 0.2% by weight relative to the total weight of the composition.

71. The paper according to claim 70, wherein the composition contains grit in an amount less than or equal to about 0.1% by weight relative to the total weight of the composition.

72. The paper according to claim 71, wherein the composition contains grit in an amount less than or equal to about 0.05% by weight relative to the total weight of the composition.

73. The paper according to claim 72, wherein the composition contains grit in an amount less than or equal to about 0.01 % by weight relative to the total weight of the composition.

74. A polymer comprising a composition made according to the process of claim 37.

75. A method of reducing grit in a composition, comprising:
(a) providing a slaked lime slurry;
(b) degritting the slaked lime slurry;
(c) combining the degritted slaked lime with at least one substrate; and
(d) precipitating the degritted slaked lime in (c) as calcium carbonate in the presence of the at least one substrate,
wherein the slaked lime slurry in (a) has an amount of grit less than the degritted lime slurry after (b).

76. The method according to claim 75, wherein the degritted slaked lime in (c) is precipitated as calcium carbonate onto the at least one substrate.

77. The method according to claim 75, wherein said at least one substrate is chosen from particulate materials and fibrous materials.

78. The method according to claim 75, wherein slaked lime slurry in (a) has an amount of grit of at least about 10,000 ppm and the degrifted lime slurry after (b) has an amount of grit less than or equal to about 1000 ppm.

79. The method according to claim 78, wherein slaked lime slurry in (a) has an amount of grit of at least about 10,000 ppm and the degritted lime slurry after (b) has an amount of grit less than or equal to about 500 ppm.

80. The method according to claim 75, wherein a source of the at least one substrate in (c) is a fiber-containing stream.

81. The method according to claim 75, wherein a source of the at least one substrate in (c) is a fines-containing stream.

82. The method according to claim 75, wherein a source of the at least one substrate in (c) is whitewater.

83. The method according to claim 75, wherein a source of the at least one substrate in (c) is a waste stream.

84. A system for producing a composition, comprising:
a slaked lime entry point for introducing slaked lime;
at least one degritter for removing grit from the slaked lime;
at least one substrate entry point for introducing at least one substrate; and
at least one reactor for receiving degritted slaked lime from the at least one degritter and at least one substrate from the substrate entry point, and for carbonating the degritted slaked lime, thereby precipitating calcium carbonate onto the at least one substrate to form the composition;
wherein the system produces a composition having grit in an amount less than or equal to about 0.5% by weight relative to the total weight of the composition.

85. The system according to claim 84, wherein said at least one degritter is a hydrocyclone.

86. The system according to claim 84, wherein said at least one degritter comprises a combination of a screen and a hydrocyclone.

87. The system according to claim 84, wherein said at least one degritter is a centrifuge.

88. The system according to claim 84, wherein the at least one substrate comprises fibers.

89. The system according to claim 84, wherein the at least one substrate comprises fines.

90. The system according to claim 84, wherein the at least one substrate is derived from whitewater.

91. The system according to claim 84, wherein the at least one substrate is derived from a waste stream.

92. The system according to claim 84, wherein the system produces a composition having grit in an amount less than or equal to about 0.3% by weight relative to the total weight of the composition.

93. The system according claim 92, wherein the system produces a composition having grit in an amount less than or equal to about 0.2% by weight relative to the total weight of the composition.

94. The system according to claim 93, wherein the system produces a composition having grit in an amount less than or equal to about 0.1% by weight relative to the total weight of the composition.

95. The system according to claim 94, wherein the system produces a composition having grit in an amount less than or equal to about 0.05% by weight relative to the total weight of the composition.

96. The system according to claim 95, wherein the system produces a composition having grit in an amount less than or equal to about 0.01% by weight relative to the total weight of the composition.

97. A system for producing a composition, comprising:
at least one substrate;
at least one source of alkaline earth metal;
at least one hydrocyclone, for degritting the source of alkaline earth metal; and
at least one reactor disposed to receive the at least one substrate and the degrifted alkaline earth metal, and for carbonating the alkaline earth metal to precipitate an alkaline earth metal carbonate in the presence of the at least one substrate;
wherein the system produces a composition having grit in an amount less than or equal to about 0.5% by weight relative to the total weight of the composition.
